(19) United States
(12) Patent Application Publication
(10) Pub. No.: US 2006/0083582 A1
(43) Pub. Date: Apr. 20, 2006

(54) Spring energized segmented-ring latch

(76) Inventor: Peter J. Balsells, Newport Beach, CA (US)

Correspondence Address: WALTER A. HACKLER, Ph.D.;PATENT LAW OFFICE, SUITE B, 2372 S.E. BRISTOL STREET, NEWPORT BEACH, CA, 92660-0755, US

(21) Appl. No.: 11/244,963

(22) Filed: Oct. 6, 2005

Related U.S. Application Data
(60) Provisional application No. 60/618,043, filed on Oct. 12, 2004.

(51) Int. Cl. B25G 3/18

(52) U.S. Cl. 403/325

(57) ABSTRACT

A latch device includes a shaft having a surface of revolution defining an insertion surface disposed at an insertion angle along with a circumferential groove. A housing is provided which includes a shaft receiving bore therethrough and a torroidal cavity with a spring disposed therein. A segmented ring is provided which includes a plurality of separate sound producing dogs circumferentially disposed about the housing bore for latching between the housing and the shaft.

The present application claims priority from U.S. Ser. No. 60/618,043 which is incorporated herewith in its entirety by this specific reference thereto.

The present invention is generally related to latching devices and is more particularly directed to applications that require positive latching with both audio and tactile confirmation of the latch engagement and consistent bi-directional connect/disconnect forces.

For many applications in the medical field, a latching device that has both audible and tactile confirmation of positive latching is very desirable. Many latching devices do not require any type of tool to provide for a secure latch between components. Latching devices such as those set forth in U.S. Pat. Nos. 4,804,290, 5,082,390, and 6,749,358 to Balsells typically utilize springs wherein the spring is in direct contact with a shaft, however continued use of such latches may cause spring damage.

The present invention utilizes a segmented-ring consisting of separate dogs between a spring and a shaft in order to minimize spring damage and latching components. In addition, the dogs provide a desired audible and tactile confirmation of latch engagement.

### SUMMARY OF THE INVENTION

A latch in accordance with the present invention generally includes a shaft having a surface of revolution defining an insertion surface disposed at an insertion angle with respect to a shaft axis. A circumferential groove in the shaft is disposed proximate the insertion surface.

A housing is provided which includes a shaft receiving bore therethrough and a torroidal cavity alignable with the circumferential groove in the shaft upon latching.

A garter type spring is disposed within the cavity and a segmented ring, which includes a plurality of separate sound producing dogs, is circumferentially disposed about the housing bore for radial movement within the cavity. The dogs are radially expanded by the insertion surface and radially contracted into the circumferential groove, by the spring, with an audible sound upon latching of the shaft to the housing.

More particularly, the present invention further comprises means for enabling positive latching between the shaft and the housing with consistent bi-directional connect/disconnect forces between a ratio of approximately 1/1 and approximately 1/20.

With further particularly, the means for enabling positive latching comprises a groove front shoulder disposed at an angle of between about 15° and about 45°, with a respect to a normal to the shaft axis, along with an insert angle of between about 5° and about 45°.

The dogs may be symmetrical in cross-section or asymmetrical in cross-section for further controlling the connect/disconnect forces. Use of an electrically conductive material for the dogs enables the latch to be utilized as an electrical connector.

The spring may comprise a radially loaded canted coil spring and in an embodiment in which the cavity is angular, the spring and coils are loaded angularly.

The spring may further comprise any one of a helical ribbon spring, cantilever spring, circular extension spring with spring coils loaded radially, or a circular canted coil extension spring.

### BRIEF DESCRIPTION OF THE DRAWINGS

The advantages and features of the present invention will be better understood by the following description when considered in conjunction with the accompanying drawings, in which:

FIG. 1 is a side view, in partial cross-section, of a device in accordance with the present invention showing, in a latched configuration, a shaft having an insertion surface along with a circumferential groove, a housing including a bore and torroidal cavity aligned with the circumferential groove, a spring disposed within the cavity, and a segmented ring including a plurality of a separate sound producing dogs which are circumferentially disposed about the housing bore;

FIG. 1A is an enlarged sectional view illustrating one of the symmetrical dogs;

FIG. 1B is a side view of the shaft shown in FIG. 1 more clearly showing an insertion surface defined by a surface of revolution disposed at an insertion angle with respect to a shaft axis;

FIG. 2 is a side view in partial cross-section of another embodiment of the present invention utilizing asymmetric dogs with the latch device in an initial insertion phase;

FIG. 2A is a cross-sectional view of the embodiment shown in FIG. 2;

FIG. 3 is an enlarged cross-sectional view of one of the asymmetric dogs shown in FIG. 2;

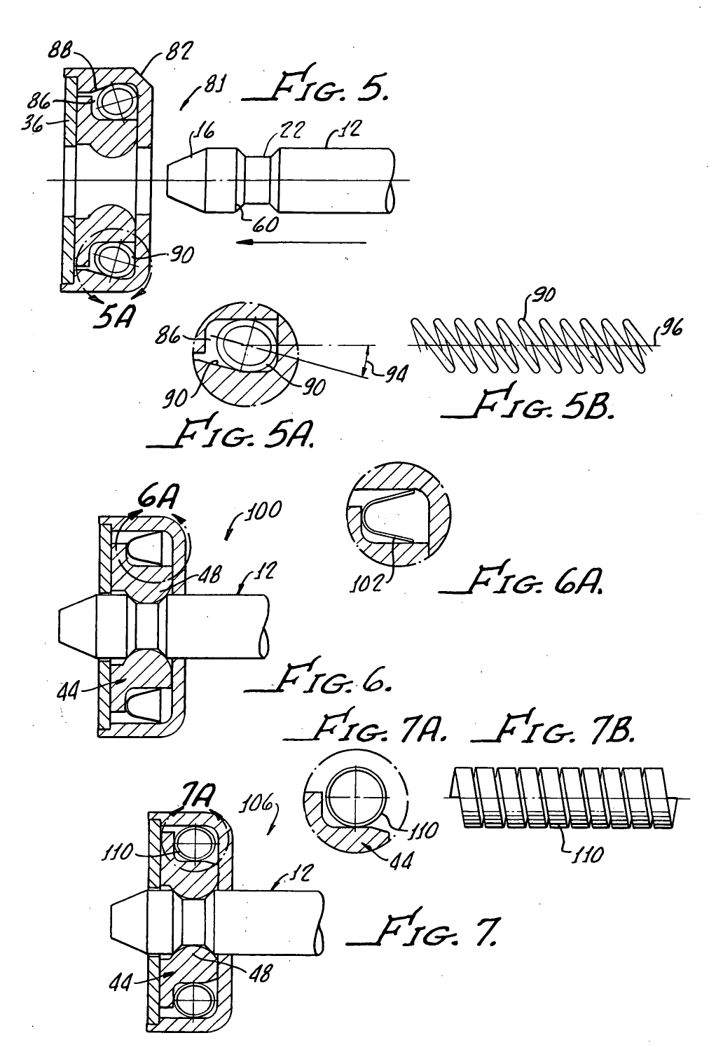

FIG. 2C further illustrates the shaft shown in FIG. 2 as having a groove front shoulder disposed at an angle of about 45° to a normal to the shaft axis;

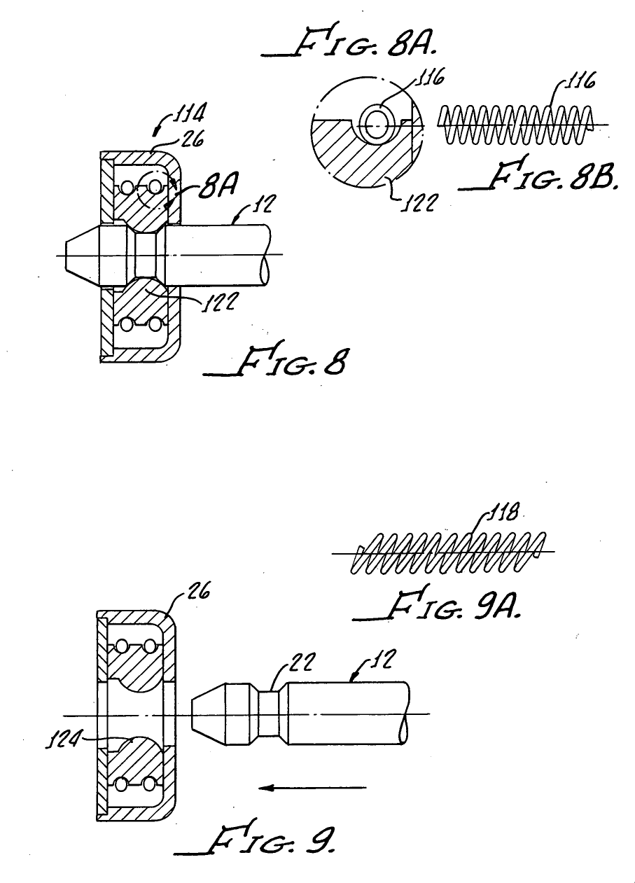

FIG. 3 illustrates the device shown in FIG. 2 in a latched position with a 5° spring deflection;

FIG. 3A is a cross-sectional view of the device shown in FIG. 3;

FIG. 3B is a side view of the shaft illustrating a front groove shoulder angle of 30°;

FIG. 4 is similar to FIG. 3 however showing a spring deflection of 25°;

FIG. 4A is a cross-sectional view of the device shown in FIG. 4;

FIG. 4B illustrates a shaft having a groove front shoulder angle of about 15°;

FIG. 5 illustrates another embodiment of the present invention utilizing an angular groove with the spring coils loaded angularly;

FIG. 5A is a cross-sectional view taken around line 5A of FIG. 5;

FIG. 5B is a side view of a canted coil spring suitable for use in the present invention;

FIG. 6 is a cross-sectional view of another embodiment of the present invention;

FIG. 6A is an enlarged view of section 6A of FIG. 6;

FIG. 7 is a cross-sectional view of yet another embodiment of the present invention;

FIG. 7A is an enlarged view of section 7A of FIG. 7;

FIG. 7B is a side view of the spring shown in FIG. 7;

FIG. 8 is a cross sectional view of a further embodiment of the present invention;

FIG. 8A is an enlarged view of section 8a of FIG. 8;

FIG. 8B is a side view of the spring shown in FIG. 8;

FIG. 9 is a cross sectional view of another embodiment of the present invention; and

FIG. 9A is a side view of the spring shown in FIG. 9.

### DETAILED DESCRIPTION

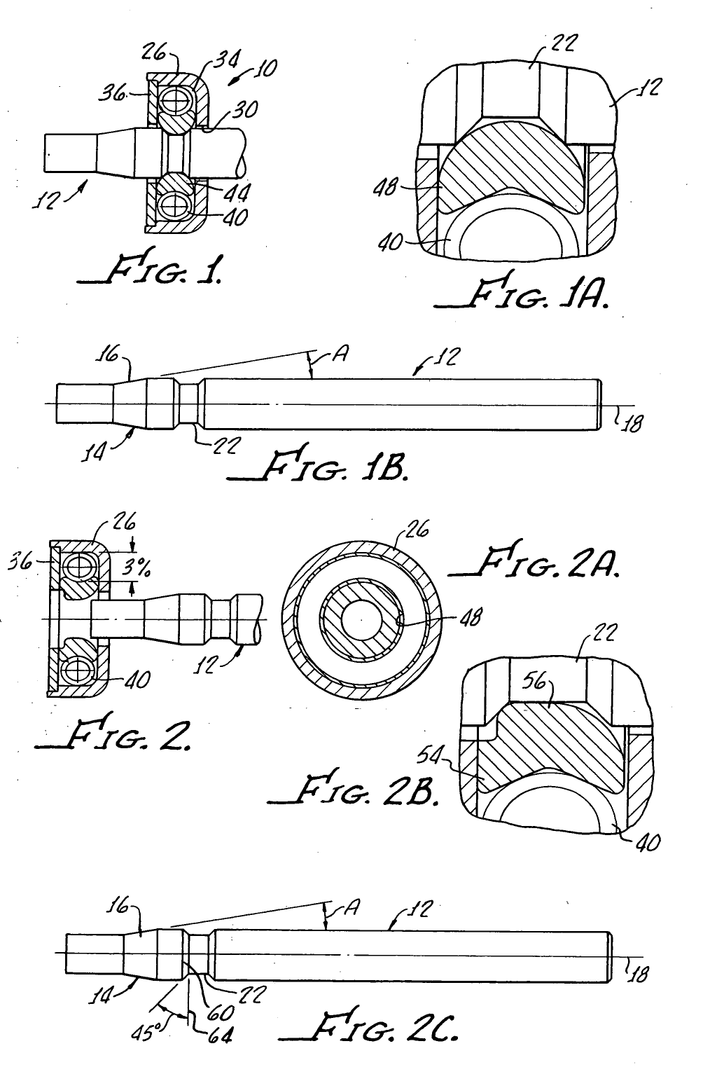

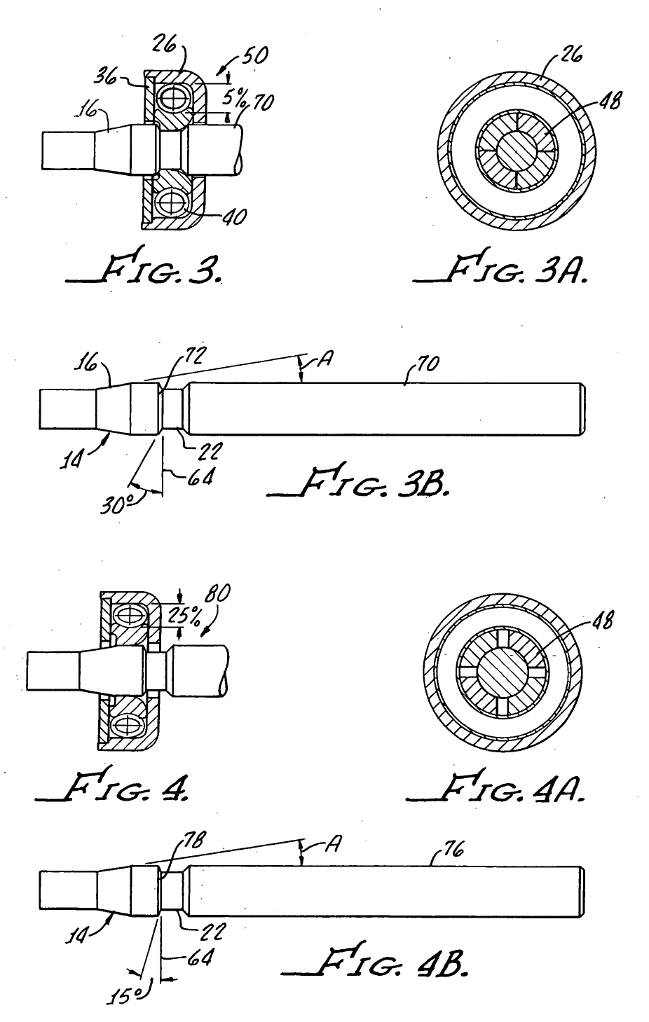

With reference to FIGS. 1, 1A, and 1B, there is shown a latch device 10 in accordance with the present invention generally including a shaft 12 having a surface of revolution 14 defining an insertion surface 16 disposed at an insertion angle A, illustrated at 10°, to a shaft axis 18.

A circumferential groove 22 is formed in the shaft 12 approximate the insertion surface 16.

A housing 26 is provided, see FIG. 1, having a shaft receiving bore 30 therethrough along with a torroidal cavity 34 which is alignable with the circumferential groove 22, as illustrated in FIG. 1. The cavity 34 may be formed in part by an end plate 36 for enabling assembly of the device 10.

A garter spring 40, which may be a canted coil spring, as set forth in the hereinabove referenced U.S. patent applications, is disposed within the cavity 34, the referenced pattern being incorporated herewith in their entirety for describing a suitable spring for use in combination with the present invention.

The segmented ring 44 comprises a plurality of separate dogs 48, see FIG. 1A, are provided and circumferentially disposed about the housing bore 30 with the dogs 48 being radially expanded by the insertion surface 16 and contractable into the circumferential groove 22, by the spring 40, upon latching of the shaft 12 to the housing 26.

Separate dogs are made from a dense material such as, for example, metal, dense plastic, or the like, and provide an audible sound when snapped into the groove 22 by the spring 40. Thus, the dogs are sound producing for enabling confirmation of the latching of the shaft 12 to the housing 26. They further provide tactical confirmation of such latching.

When the housing 26, dogs 48, and shaft 12 are made from suitable conductive materials the device 10 is suitable as an electrical connector.

Another embodiment of the device 50 is shown in FIGS. 2, 2A, 2B, and 2C, with the common reference numbers representing substantially similar or identical components.

FIG. 2 shows the latch device 50 with the shaft 12 in an initial insertion phase. As shown in FIG. 2, the spring 40 has a 3% deflection. Spring 40 deflection of about 3% establishes the holding force of the device 10, 50 for a selected spring 40.

The device 50 includes asymmetric dogs 54 as best illustrated in FIG. 2B which should be compared to the symmetric dogs 48 shown in FIG. 1A.

The asymmetric dogs include a convex shoulder 56 for engagement with a groove front shoulder 60, which as shown in FIG. 2C, is disposed at an angle of about 450 to a normal 64 to the shaft axis 18.

The groove shoulder 60 and dog 56 as well as the insertion surface 16 provide a means for enabling positive latching between the shaft 12 and the housing 26 with constant bi-directional connect/disconnect force ratios between approximately 1/1 and approximately 1/20, the 45° angle shown in FIG. 2 providing a connect/disconnect ratio of about 1 to 3.

FIGS. 3, 3A, and 3B, illustrate the embodiment 50 of the device in accordance with the present invention with a shaft 70 having a shoulder 72 at a 30° angle to a normal 64, which provides a connect/disconnect of about 1 to 6. In this embodiment, the spring 40 is shown with a 5° deflection and FIG. 3A illustrates the dogs 48 interconnected position with the groove 22.

The embodiment 80 shown in FIGS. 4, 4A, 4B is similar to that as shown in FIGS. 3-3B with a spring deflection of about 25% with a shaft 76 having a shoulder 78 at a 15° angle to the normal 64 which provides for a connect/disconnect ratio of about 1/10.

FIGS. 5, 5A, 5B illustrate yet another embodiment 81 in accordance with the present invention which includes a housing 82 in which the cavity 86 is angular, that is, having an angulated, or sloped, surface 88 and the spring 90 is disposed at an angle 94 with an axis 96.

With reference to FIGS. 6 and 6A, there is shown another embodiment of the device 100 in accordance with the present invention, common reference numbers indicating identical or substantially similar components to those earlier hereinabove described.

In this embodiment, a cantilever spring 102 is utilized for biasing the dogs 48 of the segmented ring 44.

FIGS. 7, 7A, 7B show yet another device 106 in accordance with the present invention in which a helical ribbon spring 110 is utilized biased the dogs 48 of the segmented ring 44.

With reference to FIGS. 8, 8A, 8B, there is shown an embodiment 114 utilizing either a helical extension spring 116. FIGS. 9, 9A show a canted extension spring 118 for biasing dogs 122, 124.

Although there has been hereinabove described a specific spring energized segmented-ring latch in accordance with the present invention for the purpose of illustrating the manner in which the invention may be used to advantage, it should be appreciated that the invention is not limited thereto. That is, the present invention may suitably comprise, consist of, or consist essentially of the recited elements. Further, the invention illustratively disclosed herein suitably may be practiced in the absence of any element which is not specifically disclosed herein. Accordingly, any and all modifications, variations or equivalent arrangements which may occur to those skilled in the art, should be considered to be within the scope of the present invention as defined in the appended claims.

What is claimed is:

1. A latch device comprising:
a shaft having a surface of revolution defining an insertion surface disposed at an insertion angle with respect to a shaft axis;
a circumferential groove in said shaft disposed proximate said insertion surface;
a housing having a shaft receiving bore therethrough and a torroidal cavity alignable with said circumferential groove;
a garter spring disposed within the cavity; and
a segmented ring comprising a plurality of separate sound producing dogs circumferentially disposed about the housing bore for radial movement within the cavity, said dogs being radially expanded by the insertion surface and radially contracting into said circumferential groove with an audible sound upon latching of said shaft to said housing.

2. The latch device according to claim 1 further comprising means for enabling positive latching between said shaft and said housing with consistent bi-directional connect/disconnect force ratios between approximately 1/1 and approximately 1/20.

3. The latching according to claim 1 wherein the means for enabling positive latching comprises a groove front shoulder disposed at an angle of between approximately 15° and about 45° with respect to a normal to the shaft axis and an insertion angle of between about 5° and about 45°.

4. The latch device according to claim 1 wherein the dogs are symmetrical in cross-section.

5. The latch device according to claim 1 wherein the dogs are asymmetrical in cross-section for controlling connect/disconnect forces.

6. The latch device according to claim 1 wherein the dogs are fabricated from an electricity conducting material.

7. The latch device according to claim 1 wherein the spring comprises a radially loaded canted coil spring.

8. The latch device according to claim 1 wherein the spring is selected from a group consisting of a helical ribbon spring with spring coils loaded radially; a cantilever spring; a circular extension spring with spring coils loaded radially; and a circular canted coil extension spring with spring coils loaded radially.

9. The latch device according to claim 1 wherein the cavity is angular and the spring coils are loaded angularly.

10. A latch device comprising:
a shaft having a surface of revolution defining an insertion surface disposed at an insertion angle with respect to a shaft axis;
a circumferential groove in said shaft disposed proximate said insertion surface;
a housing having a shaft receiving bore therethrough and a torroidal cavity alignable with said circumferential groove;
a garter spring disposed within the cavity;
a segmented ring comprising a plurality of separate sound producing dogs circumferentially disposed about the housing bore for radial movement within the cavity, said dogs being radially expanded by the insertion surface and radially contracting into said circumferential groove with an audible sound upon latching of said shaft to said housing; and
means for enabling position latching between said shaft and said housing with consistent bi-directional connect/disconnect force ratios between approximately 1/1 and 1/20.

11. The latching according to claim 10 wherein the means for enabling positive latching comprised a groove front shoulder disposed at an angle of between approximately 15° and about 45° with respect to a normal to the shaft axis and an insertion angle of between about 5° and about 45°.

12. The latch device according to claim 10 wherein the dogs are symmetrical in cross-section.

13. The latch device according to claim 10 wherein the dogs are asymmetrical in cross-section for controlling connect/disconnect forces.

14. The latch device according to claim 10 wherein the dogs are fabricated from an electricity conducting material.

15. The latch device according to claim 10 wherein the spring comprises a radially lowered canted coil spring.

16. The latch device according to claim 10 wherein the spring is selected from a group consisting of a helical rubber spring with spring coils loaded radially; a ribbon spring; a circular extension spring with spring coils loaded radially; and a circular canted coil extension spring with spring coils loaded radially.

17. The latch device according to claim 15 wherein the cavity is angular and the spring coils are loaded angularly.
